(19) United States
(12) Patent Application Publication
(10) Pub. No.: US 2023/0026183 A1
(43) Pub. Date: Jan. 26, 2023

(54) DYNAMIC RESOURCE MANAGEMENT ACROSS SOFTWARE-DEFINED DATA CENTERS

(71) Applicant: VMware, Inc., Palo Alto, CA (US)

(72) Inventors: Harish Manoharan, Pleasanton, CA (US); Amitabh Sural, San Jose, CA (US)

(21) Appl. No.: 17/722,008

(22) Filed: Apr. 15, 2022

Related U.S. Application Data
(60) Provisional application No. 63/225,078, filed on Jul. 23, 2021.

(51) Int. Cl. G06F 9/455; G06F 9/50

(52) U.S. Cl. CPC G06F 9/45558; G06F 9/505; G06F 9/45545; G06F 2009/4557; G06F 2009/45583; G06F 2009/45595

(57) ABSTRACT

Described herein are systems, methods, and software to dynamically manage resources across software-defined data centers. In one implementation, a monitoring service obtains flow information associated with physical network interfaces (PNICs) and virtual networking interfaces (VNICs) across a plurality of software-defined data centers (SDDCs). The monitoring service further determines when the flow information associated with the one or more workloads satisfy criteria and, in response to satisfying criteria, generates an update to a configuration associated with at least one SDDC of the plurality of SDDCs based on the flow information.

### RELATED APPLICATIONS

This application is related to and claims priority to U.S. Provisional Patent Application No. 63/225,078 entitled “DYNAMIC RESOURCE MANAGEMENT ACROSS SOFTWARE-DEFINED DATA CENTERS” filed Jul. 23, 2021, which is hereby incorporated by reference in its entirety.

### BACKGROUND

Software-defined data centers (SDDCs) are computing resources in which infrastructure elements, such as networking, storage, CPU, and the like, are virtualized and delivered as a service. In each SDDC, workloads, such as virtual machines may be initiated that can provide various applications or functions. These applications may include data processing, front-end web applications, database management applications, or some other application. In addition to providing a platform for the applications, logical networking devices may be employed that can provide routing, switching, firewalls and other logical networking operations for the virtual machines.

However, while SDDCs can provide an efficient mechanism for deploying applications and logical networks, difficulties can arise in managing the resources that are allocated to the applications and the logical networking services. In some implementations, physical resource limits associated with physical network interfaces of the hosts may cause packets to be missed or dropped. This can cause inefficiencies in the communications of virtual machines and issues with the desired operation of the SDDC.

### SUMMARY

The technology disclosed herein dynamically manages resources across software-defined data centers (SDDCs). In one implementation, a monitoring service obtains flow information associated with physical network interfaces (NICs) and virtual NICs across a plurality of SDDCs. The monitoring service further determines when the flow information associated with one or more workloads satisfy at least one criterion and, in response to satisfying the at least one criterion, generates an update to a configuration associated with at least one SDDC of the plurality of SDDCs.

### BRIEF DESCRIPTION OF THE DRAWINGS

FIG. 1 illustrates a computing environment to dynamically manage resources across SDDCs according to an implementation.

FIG. 2 illustrates a method of operating a monitoring service to dynamically manage resources across SDDCs according to an implementation.

FIG. 3 illustrates an operational scenario of dynamically managing resources across SDDCs according to an implementation.

FIG. 4 illustrates an operational scenario of dynamically managing resources across SDDCs according to an implementation.

FIG. 5 illustrates an operational scenario of dynamically managing resources across SDDCs according to an implementation.

FIG. 6 illustrates a computing system to manage resources across SDDCs according to an implementation.

### DETAILED DESCRIPTION

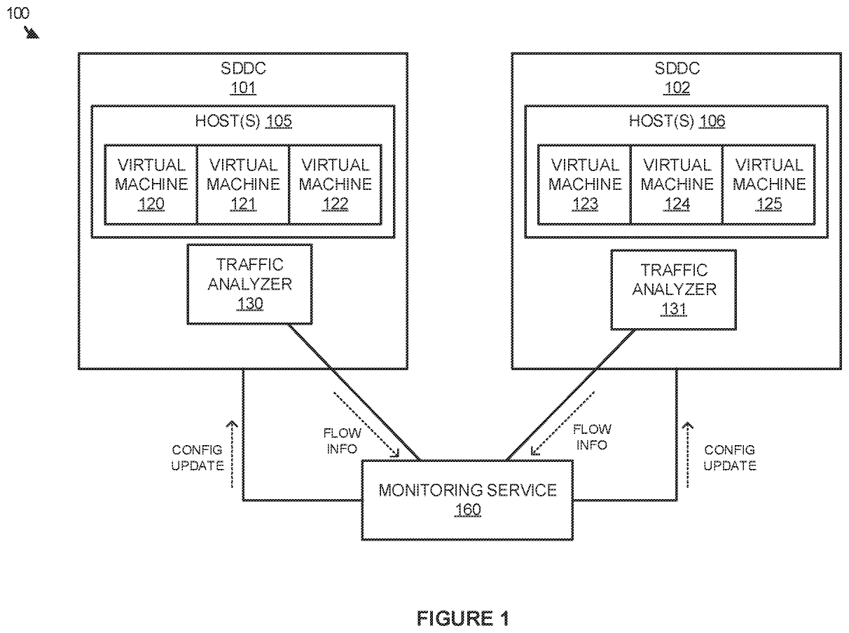

FIG. 1 illustrates a computing environment 100 to dynamically manage resources across SDDCs according to an implementation. Computing environment 100 includes SDDCs 101-102 with monitoring service 160. SDDCs 101-102 further includes hosts 105-106 with virtual machines 120-125, and further includes traffic analyzers 130-131. Although demonstrated as separate from hosts 105-106, traffic analyzers 130-131 may operate on at least one of the host systems. Furthermore, while virtual machines are shown and described herein throughout, other types of workloads, such as namespace containers, may substituted without significantly impacting the described systems and methods, and with similar beneficial result. A virtual machine is generally understood to include a logical partition of physical computer resources, an operating system, and application software running on that partition, whereas a namespace container, such as a Docker container, also referred to as “operating system-level virtualization,” is an execution space logically partitioned by the operating system running on a physical computer or virtual machine. A SDDC may use one or more physical computing systems, switches, routers, and other similar physical computing systems to provide a platform for the workloads. A SDDC may comprise a cloud SDDC located in a remote data center, an on-premises data center that is located at the office of an organization, or some other data center for the workloads. Each SDDC may be in different physical locations in some examples.

In computing environment 100, SDDCs 101-102 are each used to provide a platform for virtual machines 120-125, wherein the virtual machines may include application virtual machines, may include edge virtual machines (edge VMs), or may include some other virtual machine. As the virtual machines execute, communications may be required to both local virtual machines (i.e., local to the same host) as well as communications to external systems and virtual machines. For example, virtual machine 120 may communicate with virtual machine 123. Consequently, the packet may traverse physical network elements, including physical network interfaces (PNICs) for the hosts of virtual machines 120 and 123 to provide the communication.

To monitor the load associated with the PNICs and the virtual network interfaces (VNICs) associated with the virtual machines, traffic analyzers 130-131 are provided. In some implementations, hosts 105-106 may include an Internet Protocol Flow Information Export (IPFIX) sender that is used to identify flow information or data associated with the VNICs and PNICs on the corresponding host. In some implementations, in addition to or in place of IPFIX, the flow information may be determined using NetFlow, sflow, or some other protocol that can monitor the traffic for a PNIC or VNIC. The flow information may include bandwidth used for the VNICs and PNICs on the host, the number of packets sent or received by the VNIC or PNIC as a function of time, latency measurements, or some other flow information associated with ingress and egress communications over the network interfaces. The information may be aggregated for the hosts of each of the SDDCs and communicated to monitoring service 160. In some implementations, all the flow information may be provided to monitoring service 160. In other implementations, a portion of the flow information may be provided to monitoring service 160 that is determined by the traffic analyzer to be relevant or satisfies criteria for being provided to monitoring service 160. For example, when a VNIC uses bandwidth that satisfies a threshold, the flow information associated with the VNIC may be provided to monitoring service 160.

As the flow information is obtained from the traffic analyzers 130-131 for each SDDC, monitoring service 160 may determine when the flow information satisfies criteria to change a configuration associated with at least one SDDC. The configuration modification may be used to migrate virtual machines from a first host to a second host, may be used to update prefix information for processing packets at edge VMs, may be used to increase or decrease the number of edge VMs, or may be used to provide some other configuration modification.

In one example of migrating a virtual machine from a first host to a second host, monitoring service 160 may determine that two or more virtual machines on the first host are exceeding a resource threshold associated with the PNIC for the first host. Once identified, monitoring service 160 may select a virtual machine on the first host to migrate to the second host. The selection may be random, based on the PNIC resource usage by the virtual machine, or based on some other factor. The second host may be selected based on available resources (networking, CPU, memory, etc.) in some examples. The second host may be in the same SDDC or may be on a separate SDDC. For example, the first host may be a local (on-prem) host, while the second host may comprise a cloud-based host.

In another example of migrating a virtual machine, monitoring service 160 may determine that two virtual machines, on separate hosts, are frequently communicating based on the flow information (i.e., quantity of packets addressed between the virtual machines). The hosts for the virtual machines may be in the same SDDC or may be in separate SDDCs. To reduce the physical resources required to communicate between the virtual machines, monitoring service 160 may migrate at least one of the virtual machines, such that the virtual machines execute on the same host. For example, if virtual machine 120 frequently communicates with virtual machine 123, then at least one of the virtual machines may be migrated to permit the two virtual machines to execute on the same host. The selection of the host for the virtual machines may be based on available resources, resource requirements of the virtual machines, other communication requirements for the virtual machines (e.g., communications required with other virtual machines), or some other factor.

In some implementations, monitoring service 160 may further implement configuration modifications in association with edge VMs (sometimes referred to as edge gateways). Edge VMs are used to provide logical routing operations for the virtual machines and may further provide firewall operations, IPsec operations, or some other similar networking operation for the virtual machines. The configuration modifications may be used to transition one or more source internet protocol (IP) addresses that are pressed by an edge VM to a second edge VM, reducing the resource usage associated with the edge VM. The configuration modifications may also be used to increase or decrease the number of edge VMs in at least one SDDC. For example, if resource usage satisfies criteria for the available edge VMs, then monitoring service 160 may initiate one or more new edge VMs. Once initiated, monitoring service 160 may allocate IP prefixes to the new edge VMs, diverting traffic to the new edge VMs.

In making the modifications to each of the SDDCs, monitoring service 160 may communicate with one or more control services associated with each of the SDDCs. The control services may in turn implement the directed changes in the SDDC, wherein the control services may execute at least partially on hosts 105-106. In some implementations, prior to implementing a modification, monitoring service 160 may provide a notification via an application, web browser, email, or some other mechanism to an administrator associated with SDDCs 101-102 to indicate the suggested modifications. Once confirmed by the administrator, the configuration changes may be implemented.

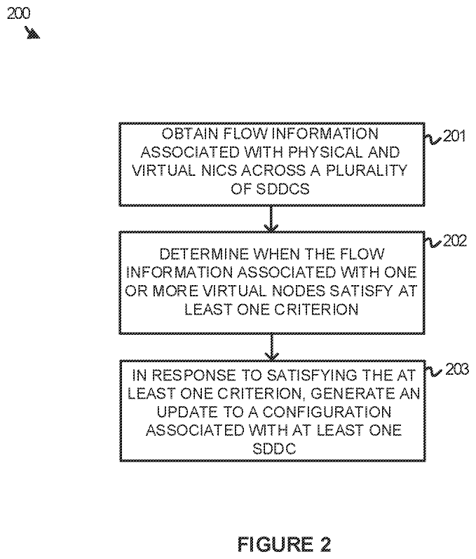

FIG. 2 illustrates a method 200 of operating a monitoring service to dynamically manage resources across SDDCs according to an implementation. The steps of method 200 are referenced parenthetically in the paragraphs that follow with reference to systems and elements of computing environment 100 of FIG. 1.

As depicted, method 200 includes obtaining (201) flow information associated with physical network interfaces (PNICs) and virtual networking interfaces (VNICs) across a plurality of software-defined data centers (SDDCs). The flow information may be provided via traffic analyzers that can provide information associated with each of the hosts in the SDDCs. The information may include bandwidth usage associated with the PNICs and VNICs, ping information associated with the PNICs and VNICs, sending and receiving IP addresses associated with the communications for the PNICs and VNICs, total packet information for the PNICs and VNICs, or some other information associated with the PNICs and VNICs. In some implementations, each of the hosts may employ IPFIX that can collect the data for PNICs and VNICs and provide the information to traffic analyzers 130-131, which in turn may forward the data to monitoring service 160. The flow information provided for each SDDC to monitoring service 160 may include all the flow information captured using IPFIX or may include a portion of the flow information captured using IPFIX. For example, a traffic analyzer may identify flow information that is relevant to the SDDC configurations (e.g., when a VNIC or PNIC exceeds a threshold number of packets) and provide the relevant flow information to monitoring service 160.

As the flow information is received, method 200 further comprises determining (202) when the flow information associated with one or more virtual machines satisfy at least one criterion. The at least one criterion may comprise a quantity of packets sent and/or received during a period, a bandwidth threshold, or some other criterion. In response to satisfying the at least one criterion, method 200 further includes generating (203) an update to a configuration associated with at least one SDDC of the plurality of SDDCs.

In one implementation, determining when the at least one criterion is satisfied may include determining when bandwidth usage of a PNIC by two or more virtual machines satisfies a threshold. In response to the usage of the PNIC satisfying the threshold, monitoring service 160 may generate a configuration modification that is used to move at least one of the virtual machines on the host with the affected PNIC to another host. The host may be in the same SDDC or may be another SDDC with hardware capable of providing a platform for the virtual machine. For example, virtual machines 120-122 may execute on the same host and exceed threshold usage of the PNIC of the host. Once identified by monitoring service 160, monitoring service 160 may select at least one virtual machine of virtual machines 120-122 to migrate to another host. The virtual machine may be selected at random, based on resource usage, or based on some other factor. Similarly, the second host may be selected based on resource availability, physical location, or some other factor.

In another implementation, in migrating virtual machines, monitoring service 160 may determine when communications between two virtual machines on separate hosts satisfy criteria, such as a quantity of packets exchanged. In response to the determination, monitoring service 160 may generate an update that migrates at least one of the virtual machines, such that the two virtual machines execute on the same host. Advantageously, PNIC resources may be saved by permitting the two virtual machines to communicate on the same host. This may also permit virtual machines to be migrated from two separate SDDCs to a single SDDC. The host selected for the virtual machines may be based on resource requirements for the virtual machines, resource availability on the host, communication requirements of the virtual machines, or some other factor.

In some examples, virtual machines in the SDDCs may be used to act as edge VMs that provide logical routing, firewalls, IPsec tunneling, or some other operations for the SDDCs. At each of the SDDCs, the traffic analyzer may collect flow information associated with the VNICs for the edge VMs and the PNICs for the hosts of the edge VMs and provide the flow information to monitoring service 160. Monitoring service 160 may determine when the flow information associated with at least one edge VM satisfies criteria and may initiate configuration modifications to the SDDC.

In one implementation, monitoring service 160 may determine when the flow information associated with an edge VM satisfies criteria indicating a large load on the edge VM (e.g., increased quantity ingress and egress packets). In response to identifying that the edge VM satisfies the criteria, monitoring service 160 may identify one or more source prefixes assigned to the edge VM and assign the prefixes to another edge VM. The prefixes are used to determine which edge VM in a SDDC will be used to provide the firewall, logical routing, and other operations in association with the packet. In some implementations, packets may be directed to an edge VM in a set of edge VMs based on the source IP prefix in the packet. This directing of the packets may be accomplished using punting (forwarding) between the edge VMs or other exchanges to forward the packets to the appropriate. As an example, a packet received from an external network element may be directed to a corresponding edge VM based on the source IP address in the packet. Here, when an edge VM is experiencing a large load, one or more of the prefixes that was allocated for processing by the edge VM may be allocated to another edge VM. The prefixes selected may be based on the flow information, wherein one or more prefixes associated with the most traffic may be assigned to another edge VM, the one or more prefixes associated with the least traffic may be assigned to another edge VM, or some other selection process for the prefixes.

In some implementations, if the flow information for the available edge VMs indicate that additional edge VMs are required, monitoring service 160 may initiate one or more new edge VMs. The triggering may include resource usage associated with the VNICs and PNICs satisfying one or more criteria. Once the new edge VMs are initiated, prefixes may be allocated to the new edge VMs from the existing edge VMs, wherein the prefixes may be selected based on load caused in association with the prefixes, randomly, or on some other basis. In some implementations, monitoring service 160 may notify a controller in the affected SDDC to initiate the edge VM and allocate the corresponding prefixes to the edge VM.

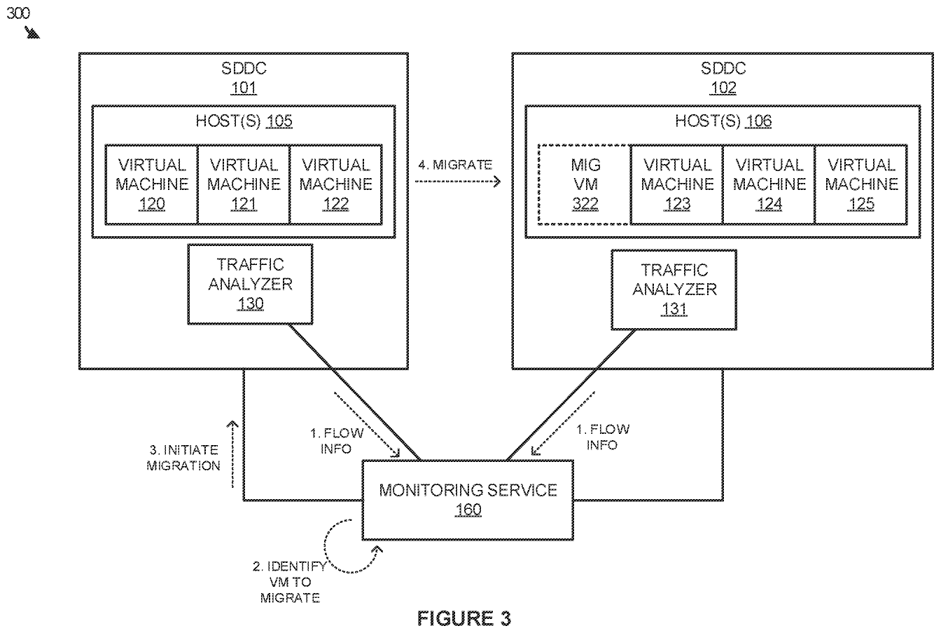

FIG. 3 illustrates an operational scenario 300 of dynamically managing resources across SDDCs according to an implementation. Operational scenario 300 includes systems and elements from computing environment 100 FIG. 1. Operational scenario 300 further includes migrated virtual machine 322 that is deployed in SDDC 102.

In operational scenario 300, traffic analyzers 130-131 provide, at step 1, flow information regarding loads on PNICs and VNICs at multiple SDDCs 101-102. The flow information may include bandwidth usage for the VNICs or PNICs, a quantity of ingress and egress packets for the VNICs or PNICs, source and destination addressing for the ingress and egress packets for the VNICs or PNICs, or some other information associated with the VNICs or PNICs in SDDCs 101-102. Based on the information, monitoring service 160 identifies, at step 2, a virtual machine 122 to migrate from a host in SDDC 101 to SDDC 102. In identifying the virtual machine for migration, monitoring service 160 may first determine that the PNIC associated with the host for the virtual machine is experiencing a load that satisfies one or more criteria. For example, the bandwidth for the PNIC of the host for the virtual machine and one or more other virtual machines on the host with the PNIC may exceed a threshold.

In response to determining that the one or more criteria are satisfied, monitoring service 160 may initiate a migration of virtual machine 122 to SDDC 102 as migrated virtual machine 322. In some implementations, monitoring service 160 may select a virtual machine on the host for migration based on the PNIC usage or load by the virtual machines on the host. For example, monitoring service 160 may select the virtual machine that is using the most bandwidth (highest load) of the PNIC for migration. The migration process may include stopping the execution of virtual machine 122 on the host in SDDC 101 and initiating execution of the host at SDDC 102. The migration may further include providing state information (e.g., processes, addressing, and the like) for the migrated virtual machine in SDDC 102. In some implementations, the second host machine may be selected based on available resources for the virtual machine, work group considerations associated with the application for the virtual machine (e.g., hardware or location requirements), or some other requirement associated with the virtual machine. Although demonstrated in the previous example as migrating the virtual machine to a separate SDDC, monitoring service 160 may initiate operations to migrate the virtual machine to a host in the same SDDC.

In some implementations, rather than separating virtual machines from one host to separate hosts, the flow information may be used to consolidate multiple virtual machines to a single host, a single rack, or a single datacenter. For example, monitoring service 160 may obtain load information that indicates that virtual machines 120 and 124 frequently communicate with one another. This indication may come from a quantity of packets exchanged between the virtual machines satisfying a threshold, a frequency of communications between the virtual machines satisfying a threshold, or some other criteria. Once it is determined that the two virtual machines satisfy criteria, monitoring service 160 may initiate a migration of the at least one of the virtual machines, such that the virtual machines execute on the same host, rack, or datacenter. The selection of the host for virtual machines 120 and 124 may be made based on available resources on the various hosts of the computing environment, other communication requirements associated with the virtual machines, application requirements for the virtual machines, hardware requirements for the virtual machines, or some other factor. As an example, virtual machine 120 may execute on a host with available resources to host virtual machine 124. Consequently, monitoring service 160 may initiate a migration of virtual machine 124 from host 106 in SDDC 102 to host 105 in SDDC 101.

In some implementations, in identifying the migration of the virtual machine from SDDC 101 to SDDC 102, monitoring service 160 may monitor the PNIC and VNIC resources to determine the cumulative communication between a virtual machine at a first SDDC and on one or more virtual machines at a second SDDC. For example, monitoring service 160 may determine that the communications for virtual machine 122 to one or more of the virtual machines in SDDC 102 satisfy one or more criteria. The criteria may include a quantity of packets, bandwidth, or some other value associated with the PNIC(s) or VNIC(s) for the communications. For example, monitoring service 160 may determine that virtual machine 122 exceeds a threshold for packets communicated with virtual machines 123-123. As a result, monitoring service 160 may initiate a migration of virtual machine 122 to SDDC 102. Advantageously, monitoring service 160 may monitor the flow information to determine when communications between SDDCs satisfy criteria to migrate one or more virtual machines. The selection of the destination hosts for the migration may be based on the proximity to the frequently communicated virtual machines. Again, if virtual machine 122 frequently communicates with virtual machines 123-124, then monitoring service 160 may identify a host, rack, and/or data center that is nearest in proximity to support the communications. The proximity may be based on latency, throughput, or some other communication parameter. Monitoring service 160 may further consider other factors including the processing resources available or other information to select the destination for the migrated virtual machine.

Although demonstrated as migrating a virtual machine from a first SDDC to a second SDDC, other operations may be performed based on an increased load. In some implementations, if all hosts at a SDDC are identifying an increased load at the PNICs for the hosts, monitoring service 160 may be used to initiate one or more new hosts that can provide a platform for the virtual machines, where a host may be initiated, and one or more virtual machines may be migrated to the one or more new hosts. The new host may be initiated in the same SDDC as the hosts with the PNICs experiencing the increased load or may be initiated in another SDDC. Similar operations may be performed to remove a host, wherein virtual machines on the host may be migrated to another host or hosts and the host may be powered down or placed in another standby mode. The host may be selected based on the number of virtual machines on the host, the load on the host, or some other factor.

In some implementations, monitoring service 160 may determine when the load on the PNICs of a SDDC satisfies criteria. In these examples, monitoring service 160 may determine that at least one virtual machine should be moved to another SDDC with more available PNIC and other computing resources. The VMs selected may be based on the resources used, the communication requirements of the VMs, or some other factor.

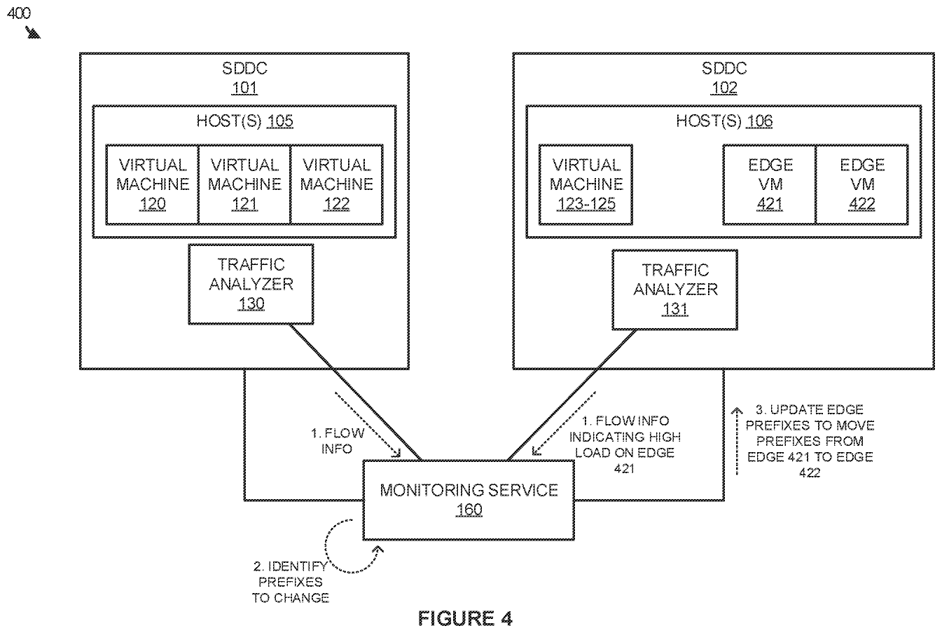

FIG. 4 illustrates an operational scenario 400 of dynamically managing resources across SDDCs according to an implementation. Operational scenario 400 includes systems and elements from computing environment 100 of FIG. 1 and further includes edge VMs 421-422.

As depicted, operational scenario 400 includes obtaining, at step 1, flow information from traffic analyzers 130-131 of SDDCs 101-102, wherein the flow information indicates a high load associated with edge 421. The high load may be indicated by a quantity of ingress/egress packets associated with the VNICs of the edge satisfying a threshold, bandwidth for the VNIC satisfying a threshold, bandwidth of the PNIC satisfying a threshold, or some other criteria, including combinations thereof. Once it is determined that edge VM 421 is encountering a high load, monitoring service 160 may identify one or more prefixes processed by edge VM 421 that should be processed by another edge VM. These prefixes are used to select an edge VM for processing based on the source IP address in the packet, wherein a packet received at the SDDC may be forwarded to an edge VM in the set of edge VMs based on the source IP prefix. In selecting the one or more prefixes, monitoring service 160 may process the flow information to identify the one or more prefixes associated with the most traffic and select the one or more prefixes to be migrated to another edge VM. The one or more prefixes may also be selected randomly, based on the number of packets received in association with the prefix, or based on some other factor.

After selecting the prefixes, monitoring service 160 may update, at step 3, the prefixes associated with edge VMs 421-422, such that the one or more prefixes are processed by edge VM 422 in place of edge VM 421. In some implementations, this may include updating hashing associated with the edge VMs, such that packets with the source IP prefixes are directed to edge VM 422 in place of edge VM 421.

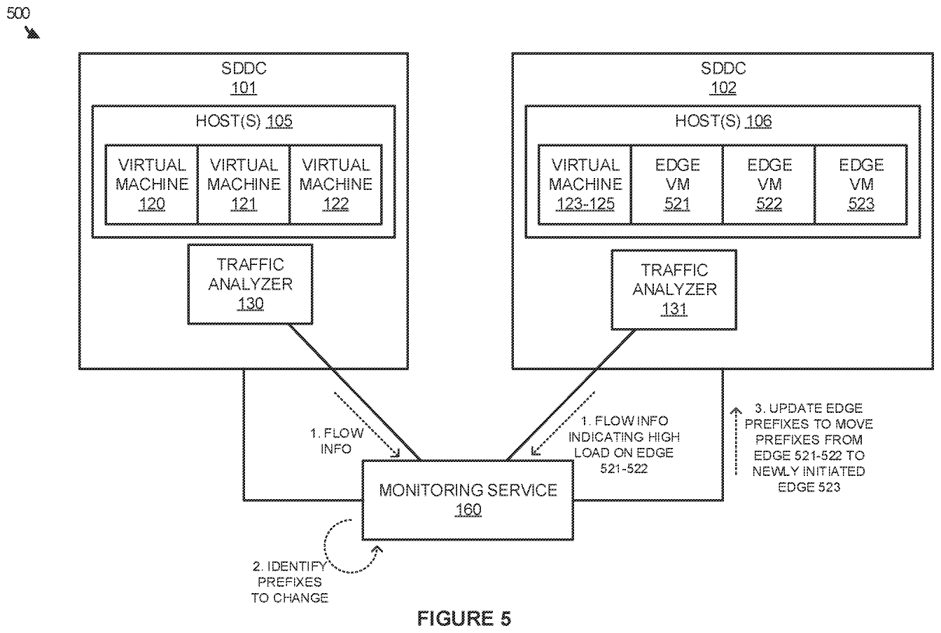

FIG. 5 illustrates an operational scenario 500 of dynamically managing resources across SDDCs according to an implementation. Operational scenario 500 incudes systems and elements from computing environment 100 of FIG. 1. Operational scenario 500 further includes edge VMs 521-523 that provide logical routing, firewalls, IPsec tunneling, or other networking operations for virtual machines in the SDDC.

As depicted, monitoring service 160 obtains flow information indicating a load that satisfies criteria for edge VMS 521-522 at step 1. The criteria may include a threshold quantity of ingress and egress packets for edge VMs 521-522, a threshold quantity of packets at a PNIC for edge VMS 521-522, or some other information associated with the VNICs for edge VMs 521-522 or PNIC(s) on the one or more hosts associated with edge VMs. In some implementations, to gather the flow information, traffic analyzers 130-131 can collect information associated with the VNIC and PNICs on the hosts for SDDCs 101-102. The information associated with the PNICs and VNICs may include a quantity of ingress and egress packets associated with the VNIC or PNIC, source and destination addressing information associated with the PNIC or VNIC, bandwidth usage associated with the PNIC or VNIC, or some other information. In some examples, traffic analyzers 130-131 may be configured as a passthrough to pass all the information to monitoring service 160. In other examples, traffic analyzers 130-131 may process at least a portion of the information to determine what flow information should be provided to monitoring service. In processing the information, traffic analyzers 130-131 may identify PNICs or VNIC associated with a threshold amount of traffic, identify a threshold number of communications between virtual machines, or identify some other criteria associated with the information from the various hosts in the SDDC. If the information satisfies the criteria, then the information may be provided as a notification to monitoring service 160

Once monitoring service 160 determines that the load associated with edge VMs 521-522 satisfies one or more criteria, monitoring service 160 may determine a configuration update for at least one of SDDCs 101-102 based on the on the flow information. Here, because edge VMs 521-522 are both associated with an increased load, monitoring service 160 may identify that a new edge VM is required and initiate edge VM 523 to assist with the increased load, at step 2. Additionally, monitoring service 160 may identify prefixes to change from edge VMs 521-522 to edge VM 523. The prefixes may be identifies based on the prefixes causing the most load, causing the least load, or based on some other factor. Once the prefixes are identified, monitoring service 160 may update, at step 3, edge prefixes associated with edge VMs 521-523, such that the one or more prefixes are processed by edge VM 523 in place of edge VMs 521-522.

While demonstrated in the example of operational scenario 500 as adding an edge VM to support increased load, monitoring service 160 may reduce the quantity of edge VMs in some examples. In one implementation, monitoring service 160 may receive flow information that indicates one or more of the edge VMs are experiencing a load that satisfies one or more reduction criteria. The one or more reduction criteria may include a threshold quantity of ingress and egress packets associated with one or more of the edge VMs or some other criteria. Once the criteria are satisfied, monitoring service 160 may consolidate two or more edge VMs into as single edge VM. This consolidation may include identifying one or more source prefixes from a first edge VM and assigning the processing of the one or more source prefixes to a second edge VM. Once assigned, monitoring service 160 may stop the execution of the first edge VM.

In some implementations, the flow information may be used to predict future migration and initiation requirements associated with the application virtual machines and the edge VMs. For example, monitoring service 160 may monitor trends associated with the load on the PNICs and VNICs based on the flow information. The trends may indicate increased usage over periods, decreased usage over periods, or some other trend. For example, the flow information may indicate that VNICs and PNICs on host experience an increased load between 5:00 and 7:00 in the morning. From the information, monitoring service 160 may generate configuration updates that can be used to reflect the predicted load in the computing environment. These configuration updates may include migrating virtual machines, initiating new edge VMs, stopping edge VMs, or some other operation. As an example, the predicted load may indicate an increased load on edge VMs between 5:00 and 7:00. Once identified, monitoring service 160 may initiate one or more additional edge VMs and assign one or more source IP prefixes to the additional edge VMs to reduce the load associated with the existing edge VMs. When the load is reduced at 7:00, monitoring service 160 may initiate an operation to stop one or more of the edge VMs and transition one or more source prefixes to being processed using the remaining edge VMs.

Although demonstrated as increasing the number of edge VMs, similar operations can be performed to decrease the number of edge VMs. In some implementations, monitoring service 160 may determine when traffic associated with edge VMs satisfies one or more criteria. Once satisfied, prefixes associated with an edge VM may be allocated to other available edge VMs and the edge VM may be placed in an unavailable state.

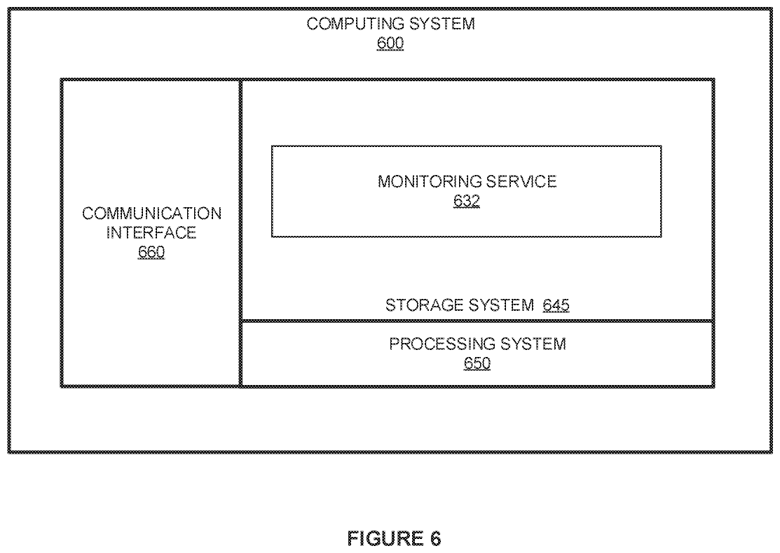

FIG. 6 illustrates a computing system 600 to manage resources across SDDCs according to an implementation. Computing system 600 is representative of any computing system or systems with which the various operational architectures, processes, scenarios, and sequences disclosed herein for a monitoring service can be implemented. Computing system 600 is an example of monitoring service 160 of FIG. 1, although other examples may exist. Computing system 600 includes storage system 645, processing system 650, and communication interface 660. Processing system 650 is operatively linked to communication interface 660 and storage system 645. Communication interface 660 may be communicatively linked to storage system 645 in some implementations. Computing system 600 may further include other components such as a battery and enclosure that are not shown for clarity.

Communication interface 660 comprises components that communicate over communication links, such as network cards, ports, radio frequency (RF), processing circuitry and software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format—including combinations thereof. Communication interface 660 may be configured to communicate with elements in one or more SDDCs, wherein the elements may include hosts, traffic analyzers, software defined networking managers, virtual machine managers, or some other element within a SDDC.

Processing system 650 comprises microprocessor and other circuitry that retrieves and executes operating software from storage system 645. Storage system 645 may include volatile and nonvolatile, removable and non-removable media implemented in any method or technology for storage of information, such as computer readable instructions, data structures, program modules, or other data. Storage system 645 may be implemented as a single storage device but may also be implemented across multiple storage devices or sub-systems. Storage system 645 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing system 650 is typically mounted on a circuit board that may also hold the storage system. The operating software of storage system 645 comprises computer programs, firmware, or some other form of machine-readable program instructions. The operating software of storage system 645 comprises monitoring service 632, which is used to provide at least the operations described in method 200 of FIG. 2. The operating software on storage system 645 may further include utilities, drivers, network interfaces, applications, or some other type of software. When read and executed by processing system 650 the operating software on storage system 645 directs computing system 600 to operate as described herein.

In at least one implementation, monitoring service 632 directs processing system 650 to obtain flow information associated with PNICs and VNICs across a plurality of SDDCs. The flow information may include bandwidth information, ingress and egress packet counts, source and destination addressing information, or some other flow information for communications over the PNICs and VNICs. In some implementations, computing system 600 may communicate with traffic analyzers at each of the SDDCs, wherein the traffic analyzers are used to provide flow information collected from one or more hosts in the SDDC. The traffic analyzers in some examples may be used to aggregate IPFIX information provided from each of the hosts supporting the SDDC. Each of the analyzers may provide all the flow information as a passthrough to computing system 600 or may provide flow information selected as relevant to computing system 600. The relevant information may include flow information that satisfies one or more criteria associated with a quantity of packets, bandwidth usage, or some other value associated with the communications for the PNICs and VNICs of the corresponding SDDC.

As the information is received by computing system 600, monitoring service 632 directs processing system 650 to determine when the flow information associated with one or more virtual machines in the SDDCs satisfy at least one criterion. The at least one criterion may correspond to a quantity of ingress and/or egress packets at a VNIC or PNIC, a quantity of packets communicated between two virtual machines, a bandwidth threshold associated with a PNIC, or some other criteria. For example, monitoring service 632 may direct processing system 650 to determine when a PNIC for a host satisfies a threshold for ingress and egress packets.

Once the at least one criterion is satisfied, monitoring service 632 directs processing system 650 to generate an update to a configuration associated with at least one SDDC of the plurality of SDDCs based on the flow information. The configuration update may be used to migrate virtual machines between hosts, initiate new virtual machines, change source prefix allocations on edge VMs, or provide some other operation to update the configuration in associated with at least one SDDC.

In one implementation, monitoring service 632 may determine when the PNIC associated with a host is experiencing increased load due to one or more virtual machines on the host. In response to identifying the increased load, monitoring service 632 may select one or more virtual machines on the host to migrate to another host, wherein the other host may operate as part of the same SDDC or another SDDC. The host can be selected based on application rules, available resources on the hosts, or some other factor. In other implementations, monitoring service 632 may migrate one or more virtual machines to the same host. This migration may occur in response to the flow information indicating that two or more virtual machines frequently communicate (i.e., satisfy frequent communication criteria). Accordingly, rather than using physical resources to communicate between multiple hosts, the migration may be used to consolidate the virtual machines to a single host.

In some implementations, the SDDCs may employ edge VMs that are used to provide logical routing, firewall services, and other similar networking services for the virtual machines in the SDDC. The edge VMs may be configured such that packets are processed by an edge VM based on the source IP address for the packet. For example, when a packet is received by an edge VM, the source addressing may be hashed to select an edge VM to process the packet. As a result of the hashing and the selection process for the edge VM, increased traffic from an IP prefix may cause an increased load at an edge VM. A configuration modification may be triggered when ingress/egress packets associated with the edge VM satisfy criteria, when ingress packets associated with one or more IP prefixes satisfy criteria, or some other criteria. In some implementations, once the criteria are satisfied, one or more of the IP prefixes associated with the affected edge may be transitioned to another edge. In other implementations, computing system 600 may initiate one or more new edge VMs to accommodate the increased load and may allocate one or more of the prefixes to be processed by the new edge VMs.

Although demonstrated in the previous example as increasing the number of edge VMs, monitoring service 632 may decrease the number of edge VMs when the flow information satisfies criteria. In reducing the edge VMs, a configuration modification may assign prefixes associated with an edge VM to one or more other edge VMs. Once assigned, monitoring service 632 may stop the execution of the edge VM.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method comprising:
obtaining flow information associated with physical network interfaces (PNICs) and virtual networking interfaces (VNICs) across a plurality of software-defined data centers (SDDCs);
determining when the flow information associated with workloads in the plurality of SDDCs satisfy at least one criterion; and
in response to satisfying the at least one criterion, generating an update to a configuration associated two or more SDDCs of the plurality of SDDCs based on the flow information.

2. The method of claim 1, wherein the flow information comprises bandwidth usage or packet counts associated with the PNICs and VNICs.

3. The method of claim 1,
wherein determining when the flow information associated with the workloads in the plurality of SDDCs satisfy the at least one criterion comprises determining that the flow information associated with a PNIC of the PNICs by the workloads on a first host at a first SDDC of the plurality of SDDCs exceeds a threshold; and
wherein generating the update to the configuration associated with the two or more SDDCs of the plurality of SDDCs comprises:
selecting a workload of the workloads to migrate from the first host to a second host at a second SDDC of the plurality of SDDCs; and
initiating a migration of the workload from the first host to the second host.

4. The method of claim 3 further comprising selecting the second host based on resource requirements of the workload.

5. The method of claim 3, wherein selecting the workload of the workloads to migrate from the first host to the second host comprises selecting the workload associated with a highest load on the PNIC.

6. The method of claim 1,
wherein determining when the flow information associated with the workloads satisfy the at least one criterion comprises determining when the flow information between a first workload at a first SDDC of the plurality of SDDCs and one or more workloads at a second SDDC of the plurality of SDDCs satisfy the at least one criterion; and
wherein generating the update to the configuration associated with the two or more SDDCs of the plurality of SDDCs comprises initiating a migration of the first workload from a host at the first SDDC to a host at the second SDDC.

7. The method of claim 6 further comprising selecting the host at the second SDDC based on the communication proximity with the one or more workloads.

8. The method of claim 1,
wherein determining when the flow information associated with the workloads satisfy the at least one criterion comprises determining when a cumulative quantity of packets between a first workload at a first SDDC of the plurality of SDDCs and a plurality of workloads at a second SDDC of the plurality of SDDCs exceeds a threshold; and
wherein generating the update to the configuration associated with the two or more SDDCs of the plurality of SDDCs comprises initiating a migration of the first workload from a host at the first SDDC to a host at the second SDDC.

9. A computing apparatus comprising:
a storage system;
a processing system operatively coupled to the storage system; and
program instructions stored on the storage system that, when executed by the processing system, direct the processing system to:
obtain flow information associated with physical network interfaces (PNICs) and virtual networking interfaces (VNICs) across a plurality of software-defined data centers (SDDCs);
determine when the flow information associated with workloads in the plurality of SDDCs satisfy at least one criterion; and
in response to satisfying the at least one criterion, generating an update to a configuration associated two or more SDDCs of the plurality of SDDCs based on the flow information.

10. The computing apparatus of claim 9, wherein the flow information comprises bandwidth usage or packet counts associated with the PNICs and VNICs.

11. The computing apparatus of claim 9,
wherein determining when the flow information associated with the workloads in the plurality of SDDCs satisfy the at least one criterion comprises determining that the flow information associated with a PNIC of the PNICs by the workloads on a first host at a first SDDC of the plurality of SDDCs exceeds a threshold; and
wherein generating the update to the configuration associated with the two or more SDDCs of the plurality of SDDCs comprises:
selecting a workload of the workloads to migrate from the first host to a second host at a second SDDC of the plurality of SDDCs; and
initiating a migration of the workload from the first host to the second host.

12. The computing apparatus of claim 11, wherein the program instructions further direct the computing apparatus to select the second host based on resource requirements of the workload.

13. The computing apparatus of claim 11, wherein selecting the workload of the workloads to migrate from the first host to the second host comprises selecting the workload associated with a highest load on the PNIC.

14. The computing apparatus of claim 9,
wherein determining when the flow information associated with the workloads satisfy the at least one criterion comprises determining when the flow information between a first workload at a first SDDC of the plurality of SDDCs and one or more workloads at a second SDDC of the plurality of SDDCs satisfy the at least one criterion; and
wherein generating the update to the configuration associated with the two or more SDDCs of the plurality of SDDCs comprises initiating a migration of the first workload from a host at the first SDDC to a host at the second SDDC.

15. The computing apparatus of claim 14, wherein the program instructions further direct the computing apparatus to select the host at the second SDDC based on the communication proximity with the one or more workloads.

16. The computing apparatus of claim 9,
wherein determining when the flow information associated with the workloads satisfy the at least one criterion comprises determining when a cumulative quantity of packets between a first workload at a first SDDC of the plurality of SDDCs and a plurality of workloads at a second SDDC of the plurality of SDDCs exceeds a threshold; and
wherein generating the update to the configuration associated with the two or more SDDCs of the plurality of SDDCs comprises initiating a migration of the first workload from a host at the first SDDC to a host at the second SDDC.

17. A system comprising:
a plurality of host computing systems distributed across a plurality of software-defined data centers (SDDCs); and
a monitoring service computing system configured to:
obtain flow information associated with physical network interfaces (PNICs) and virtual networking interfaces (VNICs) across a plurality of software-defined data centers (SDDCs);
determine when the flow information associated with workloads in the plurality of SDDCs satisfy at least one criterion; and
in response to satisfying the at least one criterion, generating an update to a configuration associated two or more SDDCs of the plurality of SDDCs based on the flow information.

18. The system of claim 17, wherein the flow information comprises bandwidth usage or packet counts associated with the PNICs and VNICs.

19. The system of claim 17,
wherein determining when the flow information associated with the workloads satisfy the at least one criterion comprises determining when the flow information between a first workload at a first SDDC of the plurality of SDDCs and one or more workloads at a second SDDC of the plurality of SDDCs satisfy the at least one criterion; and
wherein generating the update to the configuration associated with the two or more SDDCs of the plurality of SDDCs comprises initiating a migration of the first workload from a host at the first SDDC to a host at the second SDDC.

20. The system of claim 19, wherein the program instructions further direct the computing apparatus to select the host at the second SDDC based on the communication proximity with the one or more workloads.
